(19) United States
(12) Patent Application Publication
(10) Pub. No.: US 2022/0331878 A1
(43) Pub. Date: Oct. 20, 2022

(54) Three-Dimensional Printing Head Device and Ink

(71) Applicant: MetalPrinting Inc., Gyeonggi-do (KR)

(72) Inventors: Junhyeong Park, Kyeonggi-do (KR); Hyeji Park, Seoul (KR); Kicheol Hong, Busan (KR); Youngchan Kim, Gyeonggi-do (KR); Yeonsoon Yun, Seoul (KR); Young Choe, Gyeonggi-do (KR); Heeman Choe, Conroe, TX (US)

(21) Appl. No.: 17/659,555

(22) Filed: Apr. 18, 2022

Related U.S. Application Data
(60) Provisional application No. 63/176,107, filed on Apr. 16, 2021.

(51) Int. Cl. B22F 12/53; B33Y 30/00; B33Y 70/10; B22F 1/107; B22F 12/70; B33Y 40/00

(52) U.S. Cl. CPC B22F 12/53; B33Y 30/00; B33Y 70/10; B22F 1/107; B22F 12/70; B33Y 40/00

(57) ABSTRACT

A three-dimensional (3D) printing device presented in this invention has a novel printing head design that can be used with a cost-effective 3D printing ink based on cost-competitive camphene solvent utilizing its burning-free, room-temperature solidifying and sublimating properties for 3D printing purposes. The unique combination of the new printing head with pressured air control and the invented ink allows for a mass-production of complex metallic components and parts with a variety of compositions for use in advanced manufacturing in a highly cost-effective way.

### CROSS-REFERENCE TO RELATED APPLICATIONS

This patent application claims the benefit of U.S. patent application 63/176,107, filed Apr. 16, 2021, which is incorporated by reference along with all other references cited in this application.

### BACKGROUND OF THE INVENTION

The invention relates to the field of three-dimensional printing of metal parts and components and more specifically, to a print head for printing in three dimensions and ink for this print head.

There is a need for improved three-dimensional metal printing.

### BRIEF SUMMARY OF THE INVENTION

A three-dimensional (3D) printing device has a novel printing head design and is used along with a cost-effective 3D printing ink, based on camphene solvent utilizing its room-temperature solidifying and sublimating properties for 3D printing purposes. The unique combination of the new printing head and the invented ink allows for a mass-production of complex metallic components and parts with a variety of compositions for use in advanced manufacturing. Therefore, this ink-based 3D printing device does not need to heat up the printing head and thus does not cause the formation of harmful nanoparticles of a conventional plastic filament during the printing process, which is a concerning issue for 3D printing industry and academy.

Three-dimensional (3D) printing technology for metallic components and parts are of paramount importance for major industries such as transportation, energy, defense, and many others. Some 3D printing technologies include laser melting or electron beam melting 3D printing, binder jetting printing (e.g., binder-based metal injection molding 3D printing), and ink-based 3D printing. There are many advantages of ink-based 3D printing such as cost reduction and easy production of various alloy parts that are essential for use in diverse manufacturing industries.

In an implementation, the ink contents include camphene solvent, binder (e.g., mixture of polystyrene and polycaprolactone), dispersant, and metal or metal-oxide powder. For a proper mixing of the ink prior to being placed in the printing head, heating up to about 70 degrees Celsius and sonication may be used together to lower its viscosity.

In an implementation, the printing head is designed such that an air-compressor motor is connected to the printing head using a syringe dispenser to control the speed and on and off maintenance of the ink printing process. Here, the viscosity of the metal powder ink is adjusted accordingly for a good quality of ink printing via a temperature controller surrounding the syringe dispenser, which helps maintain the temperature of the ink consistently lukewarm (˜30-50 degrees Celsius) depending on the type of the metal power in the ink. Unlike the traditional filament-based printing head that requires heating up to more than 200 degrees Celsius to liquefy plastic filament, heating for melting is not required for this metal-ink printing head. This is important as the heated plastic filament in the conventional 3D printing process is known to often cause micro- or nano-sized particles, which can be harmful to human health and environment.

Due to the unique properties of camphene-based solvent, the printed product becomes dried and sublimated over time maintaining its printed form in 3D solid state. This ink-based 3D printing technology can be several tens of times more cost effective than the conventional 3D printing technologies based on selective laser sintering or binder jetting.

In an implementation, an additive (3D) printing head device includes a syringe dispenser including an ink containing camphene solvent and metal or metal oxide powder, which can be injected via a needle-type nozzle and printed additively. The syringe dispenser is connected to an air compressor via an air dispenser controller so that pressured air can be controlled and provided for the additive printing of the metal ink. The temperature of the ink in the syringe dispenser is adjusted by a temperature controller and is maintained at ambient temperature between from about 30 degrees Celsius to about 50 degrees Celsius. The camphene-solvent-based metal or metal oxide ink includes camphene solvent in a weight percent between about 2 and about 30. The metal or metal oxide ink includes metal powder or metal oxide powder in a weight percent between about 50 and about 96.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows schematic of comparison of current 3D metal printing technologies. Conventional technologies include selective laser, binder jetting, etc., whereas this invention is related to ink-based 3D printing.

FIG. 2 shows schematic description of the ink-based 3D printing head device in this invention. The printing head can move in X, Y, and Z axes relative to the printing bed. The printing head includes a syringe dispenser, a needle-type nozzle, a syringe supporter that can maintain the temperature of the ink warm in printing, and metal powder ink based on camphene solvent. A drying fan is also attached to the printing head near the needle tip to help expedite the drying and sublimation process of the camphene-based ink whenever necessary. There is an air compressor and an air dispenser connected to the printing head for a continuous supply of compressed air required to additively print the camphene-based metal ink. The movement of the printer head in X, Y, and Z axes and the degree of air pressure are adjusted using a common open-source program controlled by a tablet computer embedded on the printer.

FIG. 3 shows schematic description of how air pressure is supplied and controlled using an air compressor and a dispenser controller, both of which are connected to the printing head via air hoses.

FIG. 4 shows various 3D printed product examples created using camphene-based metal or metal oxide powder inks invented in this patent application.

FIG. 5 shows (5a) 3D printing in progress using a camphene-based steel ink used in this invention and (5b) a final sintered porcelain product made from the steel ink after sintering process.

FIG. 6 shows 3D printed copper product examples created using camphene-based copper or copper oxide powder ink invented in this patent application.

FIG. 7 shows an example of 3D printed nickel product created using camphene-based nickel oxide powder ink invented in this patent application.

FIG. 8 shows an example of 3D printed iron product created using camphene-based iron oxide powder ink invented in this patent application.

FIG. 9 shows 3D printed 316L steel product examples created using camphene-based steel powder ink invented in this patent application.

FIG. 10 shows an example of 3D printed titanium product created using camphene-based titanium powder ink invented in this patent application.

FIG. 11 shows an example of 3D printed copper-nickel product invented using camphene-based ink of a mixture of copper and nickel oxide powders.

FIG. 12 shows compositional analyses, X-ray diffraction patterns, of 3D printed product examples including copper, nickel, iron, and copper-nickel alloy created using camphene-based inks invented in this patent application.

### DETAILED DESCRIPTION OF THE INVENTION

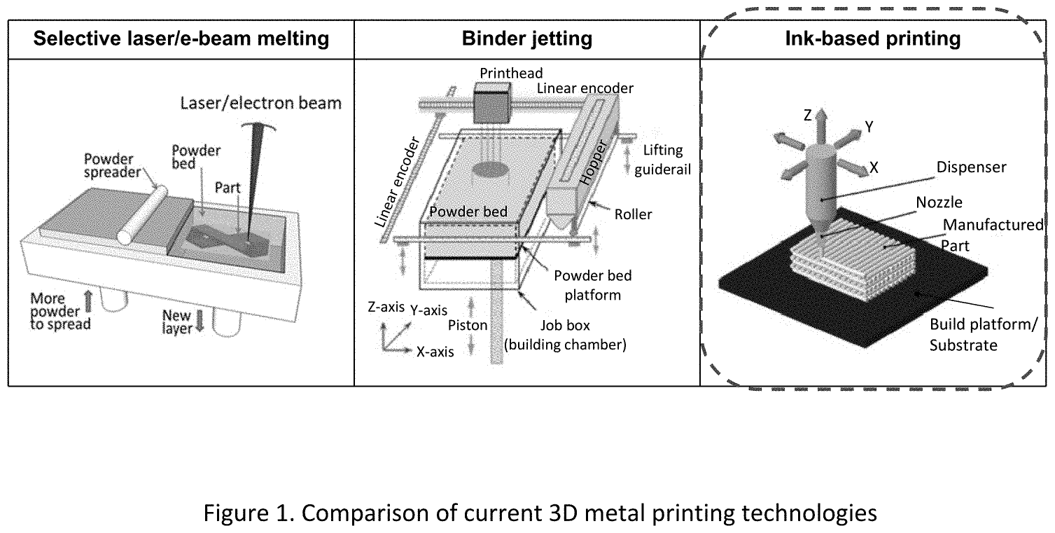

FIG. 1 schematically shows a comparison of conventional three-dimensional (3D) metal printing technologies with an ink-based 3D printing system. Conventional technologies are selective laser or e-beam melting, binder jetting, and others, all of which are very expensive (e.g., prohibitively expensive) to mass produce cost-sensitive metallic parts and components. On the other hand, a camphene-ink-based 3D printing technology is several tens less expensive than the conventional 3D printing technologies and is also easy to use with a burning-free printing process.

A traditional selective laser-melting 3D printer uses a high-energy laser to instantly sinter layer-by-layer printed metal powder into a dense metal product. On the other hand, a binder jet 3D printer uses two independent printer heads to additively print metal product green body made of a mixture of metal powder and binder, which is subsequently sintered into a final metal product. They require complex supplementary environmental support and device, which thus makes them expensive. Furthermore, their capability of manufacturing various alloy parts and component is still insufficient due to the need of using special alloy powders. An ink-based 3D metal printer can solve the issues that prevent 3D printed metal parts or metal alloy parts and components, or a combination, from being commercialized.

An ink-based metal printing system has a print head including a dispenser, nozzle (or needle). By way of a print head controller (e.g., a computer or other electronic control, smartphone, or tablet computer), the print head can move in the X, Y, and Z directions for 3D printing relative to a perpendicular direction to a surface of the printing bed or base platform (e.g., build platform or substrate). The Z direction is along (or parallel to) a perpendicular direction to the surface of the printing bed or base platform, while X and Y directions are perpendicular to each other and along the plane of the surface of the printing bed or base platform. The dispenser is filled with a liquid ink and is emitted or dispensed through an orifice or opening at the tip the nozzle. The metal ink is dispensed in droplets or as a stream depending on its viscosity and the degree of air pressure. With the metal ink, a manufacture part is additively created (e.g., added layer by layer on top of previous layers) on the build platform or substrate of the system.

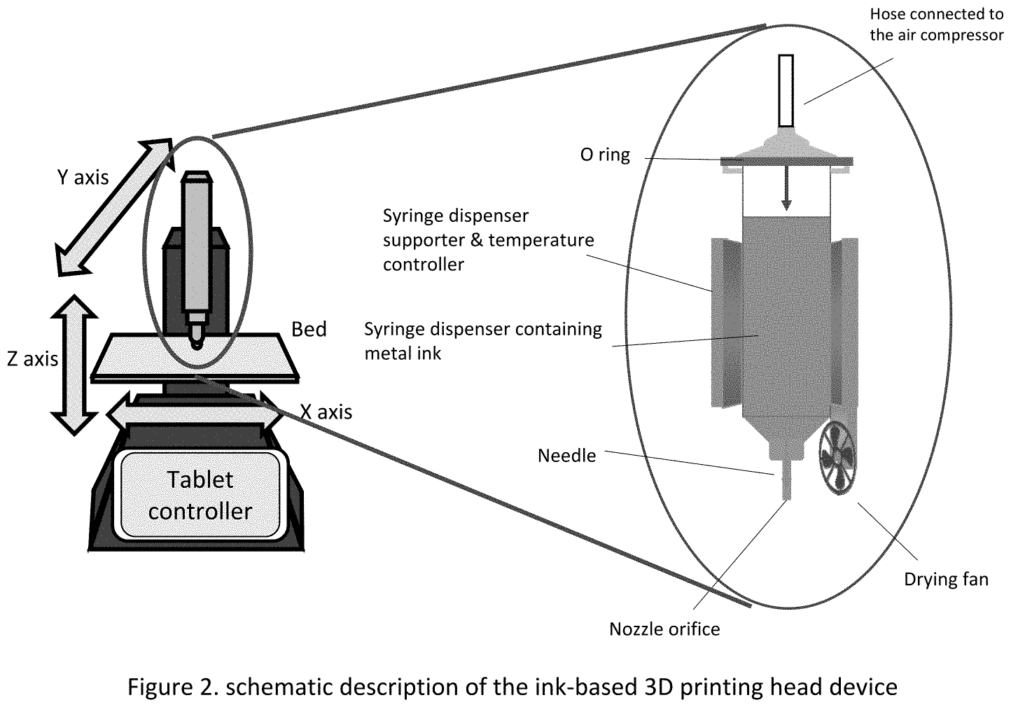

FIG. 2 shows schematic description of the ink-based 3D print head device and system in an implementation. By way of a print head controller (e.g., a computer or other electronic control, smartphone, or tablet computer), the print head can move in the X, Y, and Z directions for 3D printing relative to a perpendicular to a surface of the printing bed. A manufactured metal part will be additively formed or created by the system on a platform or bed. In an implementation, the print head can move, via a controller, in X and Y and Z directions relative to the perpendicular direction of the printing bed. In another implementation, the bed can move in X and Y and Z directions relative to print head. In an implementation, the bed can move in X and Y directions relative to print head, while the print head can move in a Z direction relative to the bed. In an implementation, the print head can move in X and Y directions relative to print head, while the bed had can move in the Z direction relative to the print head. Other combinations of movement of the head and bed relative to each other may be used.

This ink-based metal printing system has a printing head including a syringe dispenser that is filled with metal ink. The dispenser is connected to a syringe dispenser supporter or dispenser supporter and temperature controller. The temperature controller includes a heater (e.g., resistive heating element) that heats and maintains the metal ink (contained by the syringe dispenser) at a desired temperature (to keep the ink liquid and capable of flowing easily and smoothly) to have a desired viscosity.

The dispenser is connected to a metal ink injection nozzle, which is a tip of the print head. The nozzle may be a needle with a channel through it, like a syringe or injection needle. The tip of the nozzle has an opening or orifice through which the ink of the dispenser can pass and flow out of the nozzle opening.

Additionally, a fan is attached to a side of the syringe dispenser or dispenser supporter to help facilitate the drying and sublimation of the printed ink. The fan, which may be referred to as a drying fan, directs airflow toward (or away from) at the nozzle or needle, or toward (or away from) the liquid ink as it is deposited on the bed or previous layer. The drying fan helps the liquid metal ink solidify (e.g., undergo a phase change) into a solid metal more quickly. In its liquid form, metal ink has a relatively low viscosity, and after being deposited, a viscosity of the metal ink increase, until it solidifies.

The nozzle, which may also be referred to as a needle, can be removed from the dispenser and replaced with another nozzle. This allows for different nozzles to be used with the dispenser and print head, such as a nozzle with a larger or smaller diameter opening, or a different shaped opener. Some examples of nozzle opening shapes include a circle, semicircle, three-quarter circle, triangle, square, trapezoid, pentagon, hexagon, octagon, star, or other closed or polygonal shape.

In the system, the dispenser is held by a syringe dispenser supporter, which can also provide the syringe dispenser with lukewarm temperature (e.g., 30 to 50 degrees Celsius) for a proper viscosity maintenance of the ink used in printing. At an opposite end of the dispenser, opposite to the nozzle, there is a dispenser cap with an O-ring that seals the dispenser. The cap has an opening which is connected to a hose and an air compressor. The air compressor can, controlled by a controller, pulse or emit air that forces ink to be emitted or ejected by the nozzle. Depending on compressor and waveform and pressure used, the metal ink can be dispensed as droplets or as a stream. The waveform used to control the controller may be, for example, a sine wave, sawtooth wave, square wave (or pulse train), impulse, single pulse, or other. Varied pressures can be used depending on the ink used and the size of the nozzle opening, as well as the part being manufactured.

There are various aspects of an implementation of the metal or metal oxide ink printing system and technique. A flow may have additional steps (not necessarily described in this patent), different steps which replace some of the steps presented, fewer steps or a subset of the steps presented, or steps in a different order than presented, or any combination of these. Further, the steps in other implementations may not be exactly the same as the steps presented and may be modified or altered as appropriate for a particular application or based on the situation.

While examples of the embodiments are described in some detail, those descriptions and embodiments are not intended to limit the scope of the claimed invention. This patent describes some examples of implementations with specific dimensions, measurements, temperatures, and values. These are not intended to be exhaustive or to limit the invention to the precise form described. The values, percentages, times, and temperatures are approximate values. These values can vary due to, for example, measurement or manufacturing variations or tolerances or other factors. For example, depending on the tightness of the manufacturing and measurement tolerances, the values can vary plus or minus 2.5 percent, plus or minus 5 percent, plus or minus 7.5 percent, plus or minus 10 percent, plus or minus 15 percent, plus or minus 20 percent, or plus or minus 25 percent.

Further, the values are for a specific implementation, and other implementations can have different values, such as certain values made larger for a larger-scaled sized process or product, or smaller for a smaller-scaled product. A device, apparatus, or process may be made proportionally larger or smaller by adjusting relative measurements proportionally (e.g., maintaining the same or about the same ratio between different measurements). In various implementations, the values can be the same as the value given, about the same of the value given, at least or greater than the value given, or can be at most or less than the value given, or any combination of these.

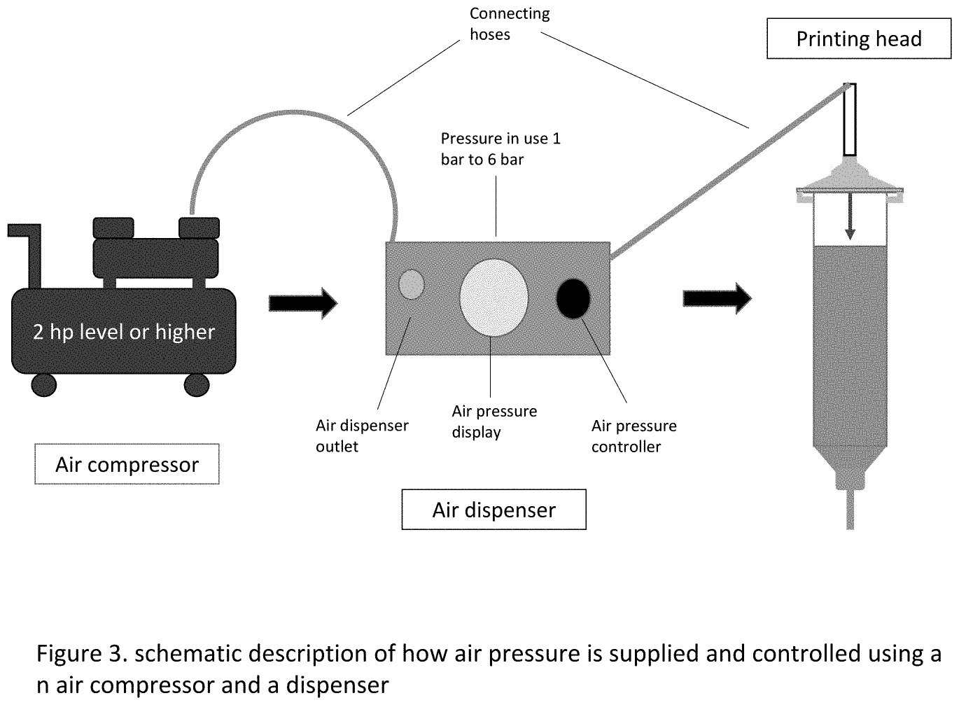

FIG. 3 shows schematic description of how air pressure is supplied and controlled using an air compressor and a dispenser. In an implementation, a combination of a pressure-assisted printing head and a camphene-based metallic ink is presented to achieve an additive metal printing. Here, the use of the air pressure, generally in the range of 1 to 6 bars (e.g., 14 pounds per square inch (psi) to 88 pounds per square inch), is used to produce well-controlled and fine 3D-printed metallic parts and components by controlling the printing speed and amount, and determining the on and off moments of printing.

An air compressor is connected via a hose to an air dispenser, which is connected via a hose to a printing head. The air compressor can be operated by electricity, gasoline, or other energy source. Further, the air compressor may be battery operated or use rechargeable matters, which would allow the air compressor and metal printing system to be portable or more easily moved from one location to another. The air dispenser has an air dispenser hole or outlet, which emits compressed air when necessary. The air dispenser has an air pressure controller, which can vary the amount of pressure used (e.g., from 1 to 6 bars depending on the ink type). The air dispenser has an air pressure display, where the amount of pressure being used is visible, such as to a user of the system. The air pressure display can be analog gauge or digital gauge (e.g., digits are displayed using OLED, LED, or LCD panel, or other computer display technology).

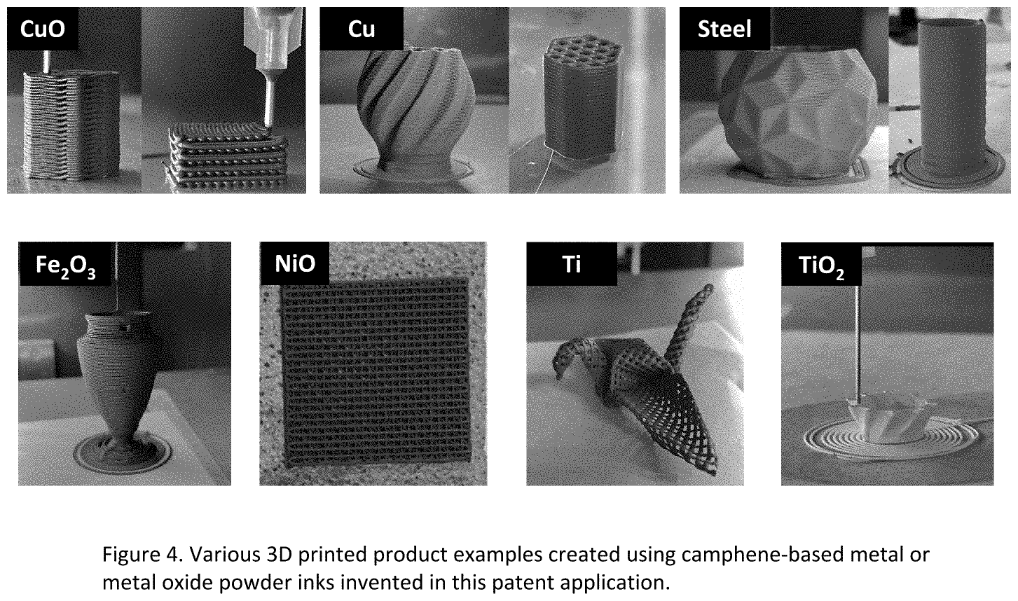

FIG. 4 shows various 3D printed product examples produced using camphene-based metal or metal oxide powder inks invented in this patent. The exemplary products include copper oxide (CuO), copper (Cu), 316L stainless steel, iron oxide (Fe2O3), nickel oxide (NiO), titanium (Ti), and titanium oxide (TiO2). Both the metal and metal oxide powders can be used to create the camphene-based inks, which can be additively printed using the pressure-assisted printing head and then sintered into designed metallic parts or components.

In an implementation, the liquid metal ink includes a camphene solvent and metal powder or metal oxide powder, or a combination of both. In an implementation, the ink constituents include camphene in a range from about 2 percent to about 30 percent, viscosity controlling agent (e.g., acetone) in a range from about 3 percent to about 20 percent, metal powder or metal oxide (or a combination) in a range from about 50 percent to about 96 percent, dispersing agent (e.g., KD-4) in a range from about 0.4 percent to about 10 percent, and a binder (e.g., a polystyrene, polycaprolactone, or their combination) in a range from about 3 percent to about 30 percent. These percentages are in weight percent.

It is desirable that the viscosity of ink is controlled before going into the printing head. The ink is in a lukewarm state in the syringe dispenser prior to being printed. When the ink is emitted out of the needle to print an object, the ink gets deposited and solidifies on the base, layer by layer. A fan is used near the needle to facilitate increasing the viscosity of the ink at the moment of printing.

For metal liquid ink printing, by using the camphene-based ink material, heating the already liquid ink to relatively high temperatures (such as 200 degrees Celsius for plastic filament) is not needed unlike in the 3D printing of the plastic filament. The metal ink is in a lukewarm state before printing. In an implementation, there is a temperature controller surrounding the ink container or dispenser to maintain the ink temperature at about 30 degrees Celsius to about 50 degrees Celsius to maintain the metal ink in a lukewarm state and control its viscosity, which is much less than 200 degrees Celsius. This is very different from conventional plastic 3D printing head where the plastic material is heated up to 200 degrees Celsius or higher to liquefy the plastic at the moment of printing; this can cause “burning” of the plastic and harmful nanoparticles.

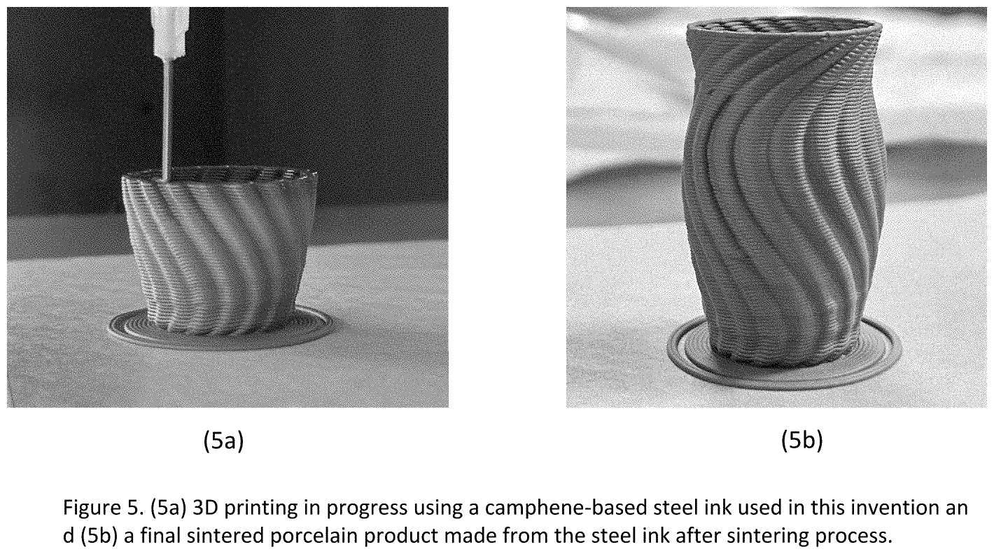

FIG. 5 shows (5a) 3D printing in progress using a camphene-based 316L stainless steel ink used in this invention and (5b) a final steel porcelain product sintered from the 3D printed green body.

A 316L stainless steel is a molybdenum-bearing grade and has properties that make it highly resistant to corrosive degradation. Typically 316L stainless steel has lower carbon levels than 316 stainless steel which make this steel easier to machine. A 316L stainless steel is easily welded by commercial processes. If forging or hammer welding, it is recommended to anneal after these processes to help avoid unwarranted corrosion. A 316L stainless steel is usually not hardenable by heat treatment, but often cold working the alloy has proven to increase hardness and tensile strength. A 316L stainless steel is sometimes known in the industry as marine grade stainless for its ability to resist pitting corrosion.

An example of a chemical formulation for 316L stainless steel is carbon 0.03 percent, manganese 2.00 percent, phosphorus 0.045 percent, sulfur 0.030 percent, silicon 0.75 percent, chromium 16 percent to 18.00 percent, nickel 10.00 percent to 14.00 percent, molybdenum 2.00 percent to 3.00 percent, nitrogen-0.10 percent, iron-balanced. Other formulations are possible and available, depending on the desired part and use.

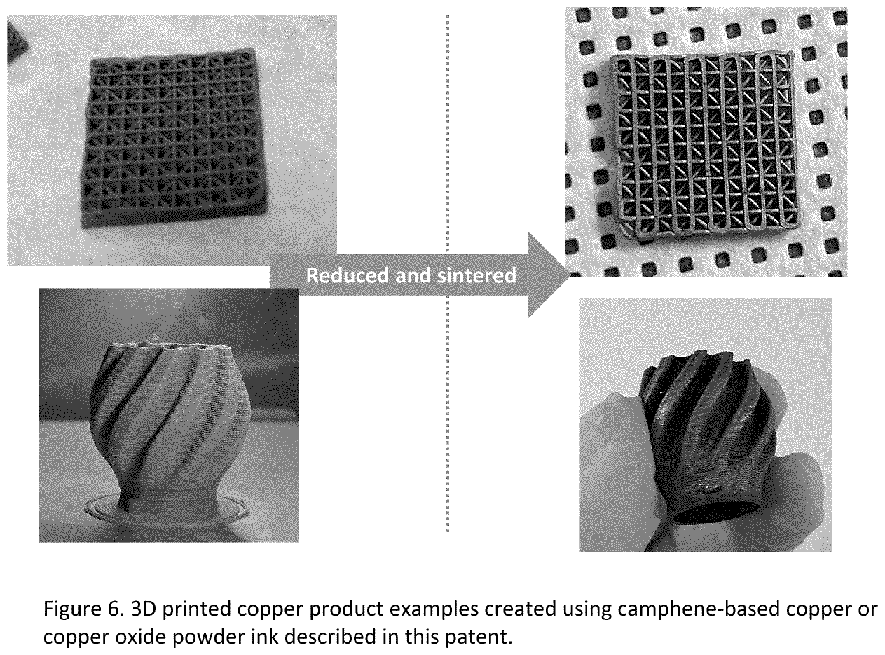

FIG. 6 shows some 3D printed copper product examples created using camphene-based copper or copper oxide powder ink invented in this patent application. Note that either copper oxide (CuO) or copper (Cu) powder can be mixed with the camphene solvent to create the ink to be printed and then sintered into the final copper product. Note that the copper or copper oxide green body was reduced at about 300 degree Celsius for about 3 hours and sintered at about 800 degrees Celsius for about 2 hours.

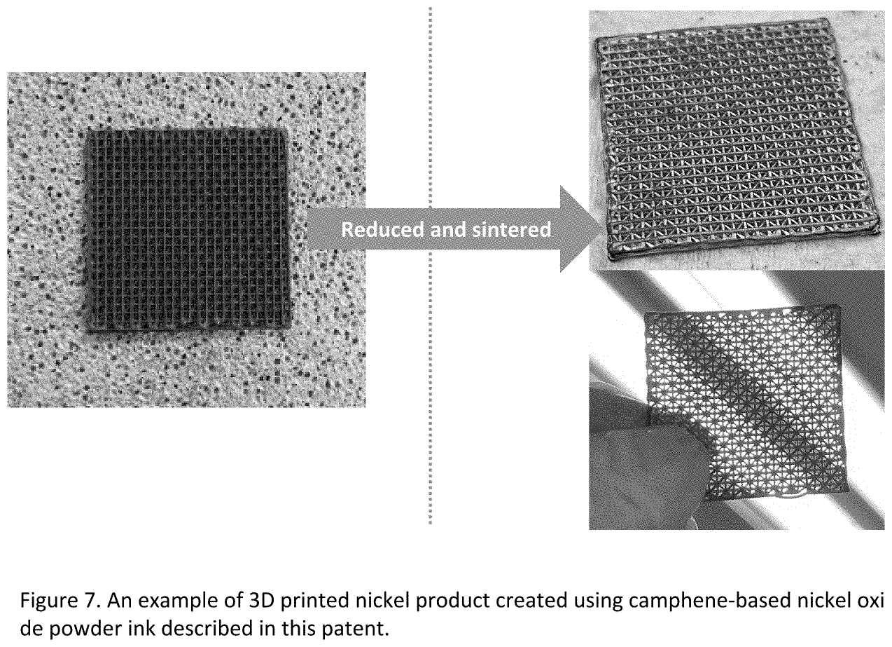

FIG. 7 shows an example of 3D printed nickel product debinded and sintered from the camphene-based nickel oxide green body. Note that the nickel oxide green body was sintered at 900 degrees Celsius for 2 hours.

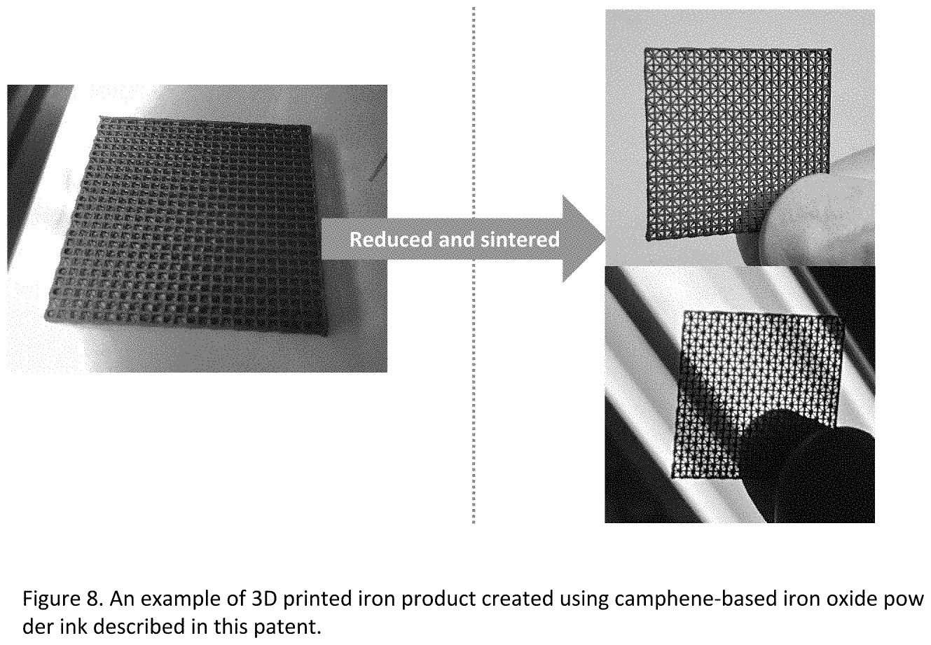

FIG. 8 shows an example of 3D printed iron product created using camphene-based iron oxide powder ink invented in this patent application. Note that the iron oxide green body was sintered at 900 degrees Celsius for 2 hours.

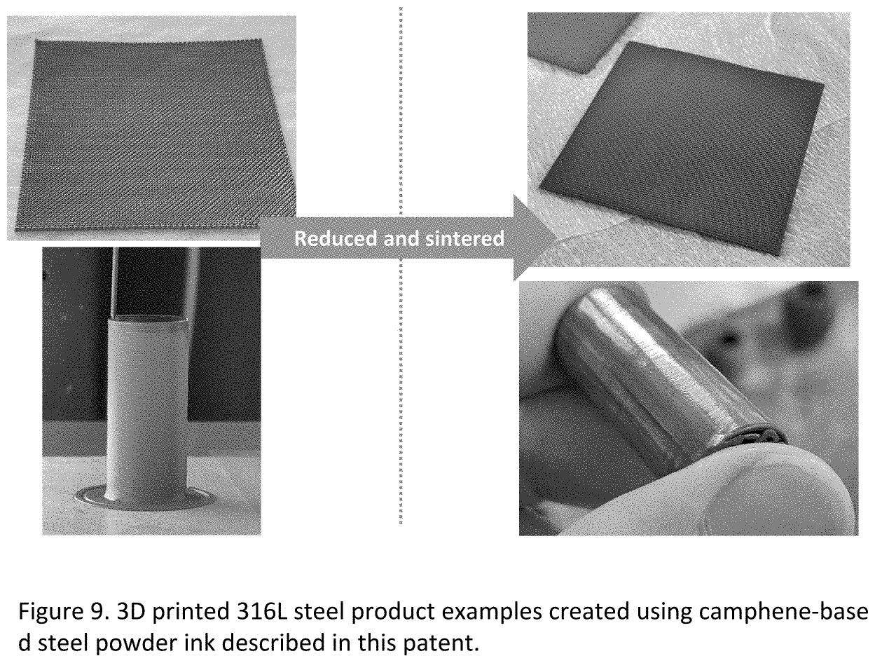

FIG. 9 shows another set of 3D printed 316L steel product examples created using camphene-based steel powder ink: steel mesh and cylinder. They both were sintered at 1000 degrees Celsius for 3 hours.

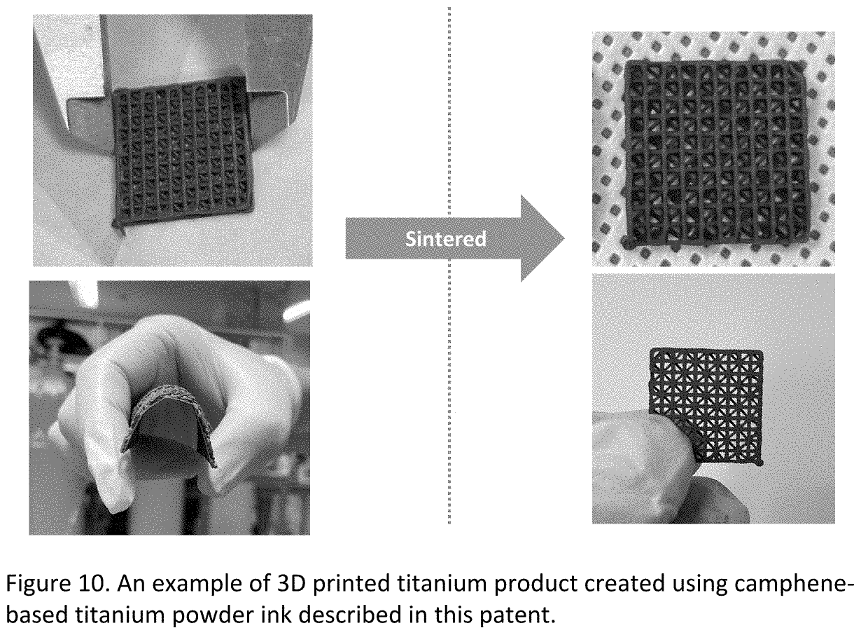

FIG. 10 shows an example of 3D printed titanium product created using camphene-based titanium powder ink described in this patent. The green-body titanium was sintered at about 900 degrees Celsius for about 3 hours.

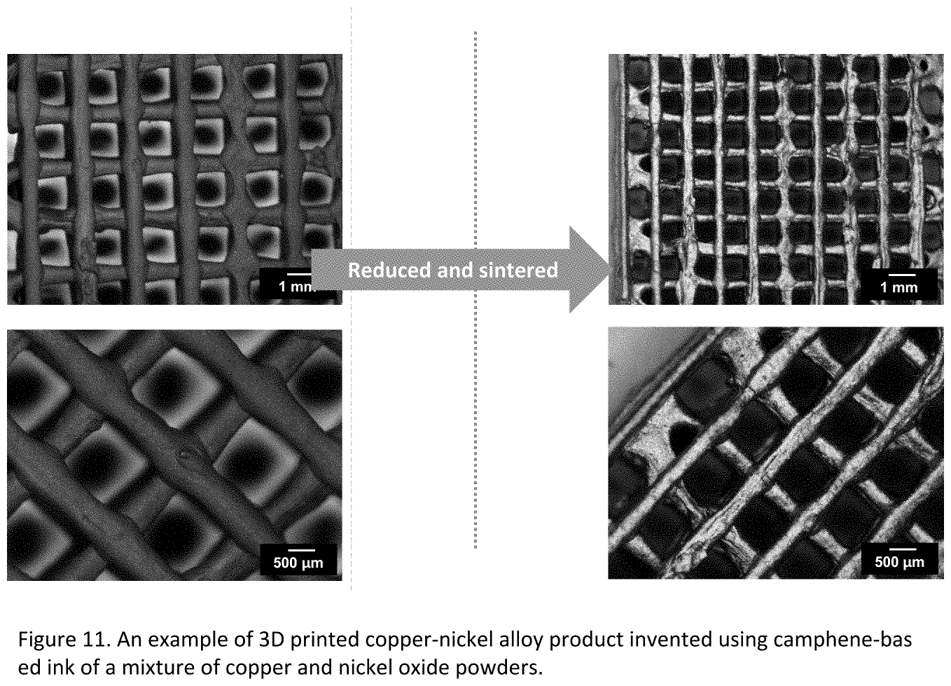

FIG. 11 shows an example of 3D printed copper-nickel product invented using camphene-based ink of a mixture of copper and nickel oxide powders. The volume ratio between the copper oxide and nickel oxide powders is 1:1 to create a complete solid-solution 50 percent copper (Cu)-50 percent nickel (Ni) alloy product.

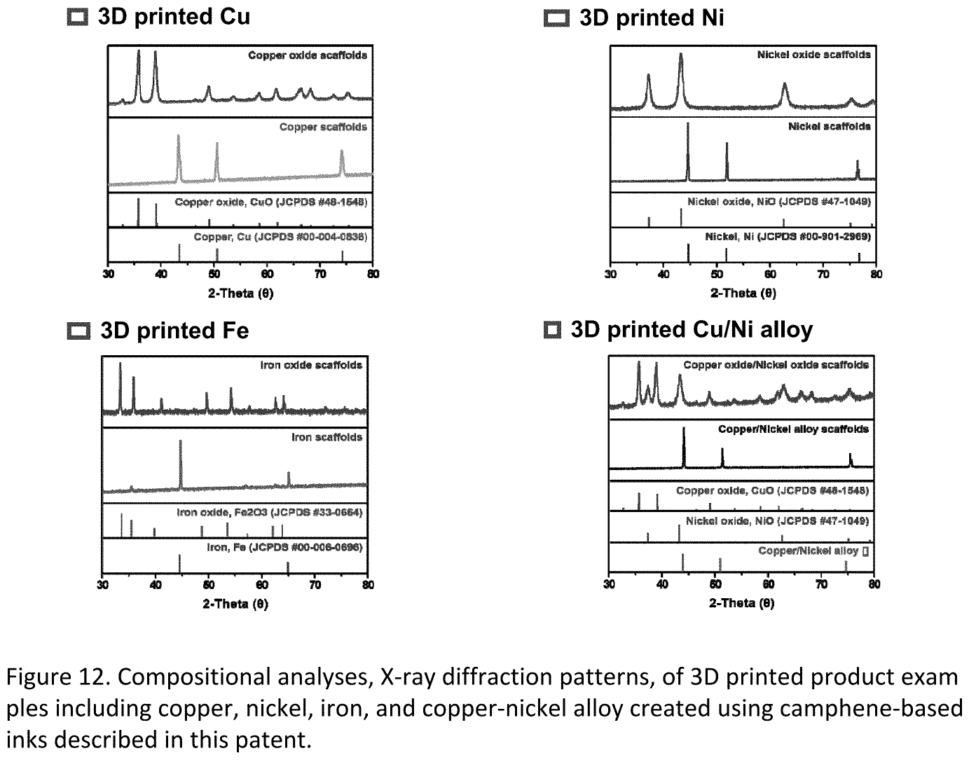

FIG. 12 show compositional analyses, X-ray diffraction patterns, of printed product examples including copper, nickel, iron, and copper-nickel alloy created using camphene-based inks invented in this patent application. They all showed only metallic diffraction patterns with no impurities or metal oxide peaks, suggesting that the debinding and sintering heat-treatment processes were performed well.

In an implementation, a device includes: a dispenser including an ink reservoir with a liquid ink including a metal powder or metal oxide powder and a camphene solvent; a nozzle, connected to the dispenser, where the nozzle includes a tip having an opening (or orifice), through which the ink can pass through, and the nozzle is removably connected to the dispenser (so that the nozzle can be removed and replaced with another nozzle, for example, of different shape or size); and a base platform, relative to which the nozzle can be positioned by an electronic controller in X, Y, and Z directions (where the nozzle is moved relative to the platform, or alternatively where the platform is moved relative to the nozzle), and the ink emitted by the nozzle is deposited on a surface of the base or on a previously deposited layer, and each layer of the ink forms a solid layer in the Z direction (e.g., relative to a surface of the base platform or a previously deposited layer) of a solid metal object being formed by the device. The liquid ink becomes a solid metal material or solid metal oxide material after being emitted by the nozzle and deposited on the base.

In various implementations, a pressure source is connected to the dispenser, such as via air hoses. The liquid ink includes camphene in a range from about 2 percent to about 30 percent and metal or metal oxide powder in a range from about 50 percent to about 96 percent. These percentages are in weight percent. The liquid ink includes a viscosity controlling agent (such as acetone) in a range from about 3 percent to about 20 percent. The liquid ink includes a dispersing agent (such as KD-4) in a range from about 0.4 percent to about 10 percent. The liquid ink includes a binder (such as polystyrene or polycaprolactone, or a combination) in a range from about 3 percent to about 30 percent.

A viscosity of ink is controlled before going into the printing head or being printed, the ink being in a lukewarm state, such as from about 30 degrees Celsius to about 50 degrees Celsius. When the ink is emitted out of the nozzle to be used for printing, the ink solidifies and gets deposited on the base platform layer by layer. There can be a fan, positioned near the nozzle or directed at or toward the nozzle to facilitate increasing the viscosity of the ink at a time of printing. The nozzle does not include a heating element, since the ink entering the nozzle is in a lukewarm state.

In an implementation, a composition of ink for three-dimensional printing includes camphene in a range from about 2 percent to about 30 percent and metal or metal oxide powder in a range from about 50 percent to about 96 percent, wherein the ink is liquid at a temperature between about 30 degrees Celsius and about 50 degrees Celsius.

In various implementations, the ink can further include a viscosity controlling agent in a range from about 3 percent to about 20 percent. The ink can further include a dispersing agent in a range from about 0.4 percent to about 10 percent. The ink can further include a binder in a range from about 3 percent to about 30 percent. The ink can further include: an acetone, which is used to control a viscosity, in a range from about 3 percent to about 20 percent, a KD-4 constituent, which is used as a dispersing agent, in a range from about 0.4 percent to about 10 percent, and a polystyrene or polycaprolactone, or a combination, which is used as a binder, in a range from about 3 percent to about 30 percent.

This description of the invention has been presented for the purposes of illustration and description. It is not intended to be exhaustive or to limit the invention to the precise form described, and many modifications and variations may be possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. An additive three-dimensional (3D) printing head device comprising:
a syringe dispenser comprising an ink containing camphene solvent and metal or metal oxide powder, which can be injected via a needle-type nozzle and printed additively.

2. The device of claim 1 where the syringe dispenser is connected to an air compressor via an air dispenser controller so that pressured air can be controlled and provided for the additive printing of the metal ink.

3. The device of claim 1 where the temperature of the ink in the syringe dispenser is adjusted by a temperature controller and is maintained at ambient temperature between about 30 degrees Celsius and about 50 degrees Celsius.

4. The device of claim 1 where the camphene-solvent-based metal or metal oxide ink, comprises a camphene solvent having a weight percent between about 2 and about 30.

5. The device of claim 1 where the metal or metal oxide ink comprises metal or metal oxide having a weight percent between about 50 and about 96.

6. A device comprising:
a dispenser comprising an ink reservoir comprising a liquid ink comprising a metal powder or metal oxide powder and a camphene solvent;
a nozzle, coupled to the dispenser, wherein the nozzle comprises a tip comprising an opening, through which the ink can pass, and the nozzle is removably coupled to the dispenser; and
a base platform, relative to which the nozzle can be positioned by an electronic controller in X, Y, and Z directions, and the ink emitted by the nozzle is deposited on a surface of the base or on a previously deposited layer, and each layer of the ink forms a solid layer in the Z direction of a solid metal object being formed by the device,
whereby the liquid ink becomes a solid metal or metal oxide material after being emitted by the nozzle and deposited on the base.

7. The device of claim 6 wherein a pressure source is coupled to the dispenser.

8. The device of claim 6 wherein the liquid ink comprises camphene in a range from about 2 percent to about 30 percent and metal or metal oxide powder in a range from about 50 percent to about 96 percent.

9. The device of claim 8 wherein the liquid ink comprises a viscosity controlling agent such as acetone in a range from about 3 percent to about 20 percent.

10. The device of claim 8 wherein the liquid ink comprises a dispersing agent such as KD-4 in a range from about 0.4 percent to about 10 percent.

11. The device of claim 8 wherein the liquid ink comprises a binder such as a polystyrene or polycaprolactone, or a combination in a range from about 3 percent to about 30 percent.

12. The device of claim 6 wherein a viscosity of ink is controlled before going into the printing head or being printed, the ink being in a lukewarm state, such as from about 30 degrees Celsius to about 50 degrees Celsius.

13. The device of claim 12 wherein when the ink is emitted out of the nozzle to be used for printing, the ink solidifies and gets deposited on the base platform layer by layer.

14. The device of claim 13 comprising a fan, positioned near the nozzle to facilitate increasing the viscosity of the ink at a time of printing.

15. A composition of ink for three-dimensional printing comprising:
camphene in a range from about 2 percent to about 30 percent and metal or metal oxide powder in a range from about 50 percent to about 96 percent, wherein the ink is liquid at a temperature from about temperature between about 30 degrees Celsius and about 50 degrees Celsius.

16. The composition of claim 15 wherein the ink further comprises a viscosity controlling agent in a range from about 3 percent to about 20 percent.

17. The composition of claim 15 wherein the ink further comprises a dispersing agent in a range from about 0.4 percent to about 10 percent.

18. The composition of claim 15 wherein the ink further comprises a binder in a range from about 3 percent to about 30 percent.

19. The composition of claim 15 wherein the ink further comprises
an acetone to control viscosity in a range from about 3 percent to about 20 percent,
a KD-4 dispersing agent in a range from about 0.4 percent to about 10 percent,
and a binder of polystyrene or polycaprolactone, or a combination, in a range from about 3 percent to about 30 percent.
